(19) United States
(12) Patent Application Publication
(10) Pub. No.: US 2005/0130042 A1
(43) Pub. Date: Jun. 16, 2005

(54) Materials for positive electrodes of lithium ion batteries and their methods of fabrication

(75) Inventors: Huiquan Liu, Shenzhen (CN); Xinying Zhou, Shenzhen (CN)

Correspondence Address: EMIL CHANG;LAW OFFICES OF EMIL CHANG, 874 JASMINE DRIVE, SUNNYDALE, CA, 94086, US

(73) Assignee: BYD America Corporation

(21) Appl. No.: 11/010,041

(22) Filed: Dec. 10, 2004

Related U.S. Application Data
(63) Continuation-in-part of application No. 10/823,931, filed on Apr. 14, 2004.
(63) Continuation-in-part of application No. 10/841,760, filed on May 8, 2004.
(63) Continuation-in-part of application No. 10/918,580, filed on Aug. 13, 2004.

(30) Foreign Application Priority Data
Dec. 11, 2003 (CN) 200310112600.9

(51) Int. Cl. H01M 4/52; H01M 4/50; C01G 45/12; C01G 51/04; C01G 53/04

(52) U.S. Cl. 429/231.3; 429/223; 429/224; 252/182.1; 423/599; 423/594.4; 423/594.6

(57) ABSTRACT

This invention discloses materials for positive electrodes of secondary batteries and their methods of fabrication. Said materials comprise of granules of an active material for positive electrodes coated with an oxide layer. The active material is one or more of the following: oxides of lithium cobalt, oxides of lithium nickel cobalt, oxides of lithium nickel cobalt manganese, oxides of lithium manganese, LiCoO₂, LiNi₁₋ₓCoₓO₂, LiNi_{1/3}Co_{1/3}Mn_{1/3}O₂, and LiMn₂O₄. The non-oxygen component in the oxide layer is one or more of the following: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B. Said non-oxygen component of the granules is between 0.01 wt. % to 10 wt. % of said granules of active material. The methods of fabrication for said materials includes the steps of mixing an additive and an active material for positive electrodes uniformly in water or solvent, evaporating said solvent or water, and heat treating the remaining mixture at 300° C. to 900° C. for between 1 hour to 20 hours. The additive is a compound of one or more of the following elements: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B where the element is between 0.01 wt. % to 10 wt. % of said active material. Using the materials of positive electrodes disclosed above or materials for positive electrodes fabricated in the methods disclosed above in batteries produces batteries with excellent cycling and high temperature properties.

### CROSS REFERENCES

This application is a continuation-in-part of the following U.S. patent applications: “Compounds of Lithium Nickel Cobalt Metal Oxide and the Methods of their Fabrication, having a U.S. patent application Ser. No. 10/823,931, filed on Apr. 14, 2004; “Improved Lithium Nickel Cobalt Oxides and Their Methods of Fabrication, having a U.S. patent application Ser. No. 10/841,760, filed on May 8, 2004; and “Positive Electrodes for Rechargeable Batteries”, having a U.S. patent application Ser. No. 10/918,580, filed on Aug. 13, 2004. These applications are incorporated herein by reference.

This application claims priority from the following Chinese patent applications:
“Materials for Positive Electrodes of Lithium Ion Batteries and Their Method of Fabrication” filed on “Dec. 11, 2003”, having a Chinese Application No. 200310112600.9. The above application is incorporated herein by reference.

### FIELD OF INVENTION

This invention relates to materials for positive electrodes of lithium ion batteries and their methods of fabrication. Particularly, it relates to materials and their methods of fabrication for positive electrodes of lithium ion batteries with excellent cycling and high temperature properties.

### BACKGROUND

As electronic devices, especially portable electronic devices, become more complex and smaller, demands made on the power sources for these devices have increased accordingly. These power supplies are required to have higher capacities, longer cycling life, excellent high temperature properties, and excellent high rate discharge and overcharge resistant properties. In the last decade, lithium ion batteries have developed rapidly and have been widely used because of their excellent overall properties.

The properties of the materials for positive electrodes directly affect the effectiveness of lithium ion batteries. At present, the most widely used active materials for positive electrodes are LiCoO₂, LiMn₂O₄, LiNiO₂, and LiNi₁₋ₓCoₓO₂ (0<x<1). During the repeat charging and discharging cycles of the batteries, the lattices of these active materials for positive electrodes can easily deform and the material can decompose and produce oxygen, especially when the charging voltage reaches above 4.2V. This phenomenon increases a battery's internal pressure, causes the destructive oxidization of the non-aqueous electrolyte, and, lowers the thermo-stability and safety of batteries.

The trace water in the non-aqueous electrolyte of lithium ion batteries also reacts with lithium salts such as LiPF6 in the electrolyte to produce HF acid. HF acid reacts with the surface of the active materials for positive electrodes, damaging the crystal structure of the active materials. This results in the deterioration of the cycling properties of batteries, which becomes more apparent at high temperatures.

In addition, during the charging and discharging process of the lithium ion batteries, the diffusion rate of the lithium ions in the crystal lattices of these active materials is significantly lower than that in the electrolyte solution. This causes a large gradient in the concentration of lithium ions at the surface between the materials for positive electrodes and the electrolyte solution, and, lower ion conductivity. Therefore, the capacity of these batteries easily decreases during the cycling process.

In order to improve the electrochemical properties of these materials, Japanese Patent 2001-143703 disclosed the method of adding extra-fine alumina powder to lithium cobalt oxide, and heating treating the mixture such that the particles of aluminum oxide and the lithium cobalt oxide were in close and tight contact. However, this method of mixing solid materials can easily lead to the non-uniform mixing of these two substances resulting in a non-uniform material for the positive electrodes.

U.S. Pat. No. 6,555,269 B2 disclosed a positive active material for a rechargeable lithium battery and a method of preparing that material. The positive active material included a LiCoO.sub.2 core and a metal selected from a group consisting of Al, Mg, Sn, Ca, Ti, Mn and mixtures thereof. The metal has a concentration gradient from a surface of the core to the center of the core. The method of preparing a positive active material for a rechargeable lithium battery included the steps of dissolving a metal compound in alcohol to prepare a metal compound solution in a sol state, coating LiCoO.sub.2 with the metal compound solution in the sol state and sintering the coated LiCoO.sub.2 at 150 to 500° C.

U.S. Pat. No. 6,569,569 B1 disclosed a positive active material for a lithium secondary battery. LiaNi1-x-yCoxMyO2-zFz and LiaNi1-x-yCoxMyO2-zSz powders (where M is a metal selected from the group consisting of Al, Mg, Sr, La, Ce, V, and Ti, and 0≦x<0.99, 0.01≦y<0.01, 0.01≦z≦0.01, and 1.00≦a≦1.1) were used. An oxygen in LiaNi1-x-yCoxMyO2 was substituted with F or S to increase the durability, capacity and structural safety of the positive active material.

Samsung company's patent CN1274956A disclosed a method of adding substances such as Si, B, Ti, Ga, Ge, Al or their respective oxides to active materials for positive electrodes such as lithium manganese oxide and lithium nickel cobalt manganese oxide. However, again, this method of mixing solid powders can easily result in the non-uniform mixing of the two substances. In addition, without heat treatment after mixing, the additives and the active material must necessarily not be in joined as closely or tightly and the resulting material is not as effective.

Japanese Patent 2001-28265 disclosed a method treating the surface of LiₐNi_{1-x-y}CoₓM_{y}O₂ with a metal alkoxide solution, then heat-treated the resulting substance to obtain a metal oxide coating. Similarly, Japanese Patent 2001-256989 formed a metal oxide layer on the front surface of the active materials for positive electrodes by treating the active materials with a metal alkoxide solution. However, both treatments in the two patents involve the use of a metal alkoxide solution, an unsafe product that can become a hazard in the manufacturing process.

Due to the limitations of the prior art, it is therefore desirable to have novel fabrication methods for novel materials that have good electrochemical properties such that when these materials are used as materials for positive electrodes of batteries, the batteries have excellent cycling and high temperature properties.

### SUMMARY OF INVENTION

An object of this invention is to disclose materials for positive electrodes and methods of fabricating materials for positive electrodes which, when said materials are used in lithium ion batteries, produce batteries with excellent cycling, high temperature, high rate discharge, and, overcharge resistance properties.

Another object of this invention is to disclose methods for fabricating materials for positive electrodes of lithium ion batteries that are simple and easy to manufacture.

Briefly, the present invention relates to materials for positive electrodes and their methods of fabrication. Said materials comprise of granules of an active material for the positive electrodes where the surface of each granule is coated with an oxide layer (also referred to as oxide coating). The active material is one or more of the following: oxides of lithium cobalt, oxides of lithium nickel cobalt, oxides of lithium nickel cobalt manganese, oxides of lithium manganese, LiCoO₂, LiNi₁₋ₓCoₓO₂, LiNi_{1/3}Co_{1/3}Mn_{1/3}O₂, and LiMn₂O₄. The non-oxygen component in the oxide layer is one or more of the following: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B. Said non-oxygen component of the oxide coating is between 0.01 wt. % to 10 wt. % of said respective granule of active material. The methods of fabrication for said materials includes the steps of mixing an additive with granules of an active material for positive electrodes in water or solvent, evaporating said solvent or water, and heat treating the mixture at 300° C. to 900° C. for between 1 hour to 20 hours. The additive is a compound of one or more of the following elements: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B where the element is between 0.01 wt. % to 10 wt. % of said active material.

An advantage of this invention is that the materials disclosed and the materials fabricated by the methods disclosed, when used for the positive electrodes in lithium ion batteries, produces batteries with excellent cycling, high temperature, high rate discharge, and overcharge resistant properties.

Another advantage of the methods disclosed in this invention is that the fabrication methods are simple and easy to implement in a manufacturing process.

### DESCRIPTION OF DRAWINGS

The foregoing and other objects, aspects and advantages of the invention will be better understood from the following detailed description of preferred embodiments of this invention when taken in conjunction with the accompanying drawings in which:

FIG. 1 is a XPS graph of an embodiment of the materials for positive electrodes.

FIG. 2 is a XRD graph of an embodiment of the materials for positive electrodes.

FIG. 3 is a scanning electron micrograph of an embodiment of the materials for the positive electrode.

### DETAILED DESCRIPTION OF THE PREFERRED EMBODIMENTS

The presently preferred embodiments of the present invention direct to a class of materials for positive electrodes of lithium ion batteries. The materials comprise of granules of active material for positive electrodes of lithium ion batteries, where the surface of each granule is covered, i.e., coated with an oxide layer (also referred to as oxide coating). The active material for the positive electrode for the embodiments is comprised of one or more of the following: oxide of lithium cobalt oxide, LiCoO₂, oxide of lithium nickel cobalt, LiNi_{1-X}Co_{X}O₂, LiNi_{1-X}Co_{X}O₂ where (0<x<1), oxide of lithium nickel cobalt manganese, LiNi_{1/3}Co_{1/3}Mn_{1/3}O₂, oxide of lithium manganese oxide, and, LiMn₂O₄. The non-oxygen component in the oxide layer of said granules is between 0.01 wt. % to 10 wt. % of the respective granules of active material for the positive electrodes. The non-oxygen component of said oxide coating is one or more of the following metals: aluminum, magnesium, zinc, calcium, barium, strontium, lanthanum, cerium, vanadium, titanium, tin, Al, Mg, Zn, Ca, Ba, Sr, La, Ce, V, Ti, and Sn, or the following nonmetals: silicon, boron, Si, and B. In other words, the oxide layer is the oxide of one or more of the following metals: aluminum, magnesium, zinc, calcium, barium, strontium, lanthanum, cerium, vanadium, titanium, tin, Al, Mg, Zn, Ca, Ba, Sr, La, Ce, V, Ti, Sn or the following nonmetal: silicon, boron, Si, and B. The average granule diameter of the granules of active material for positive electrodes for some embodiments of this class of materials is between 4 microns and 12 microns. A preferred selection is for the average granule diameters to be between 10 microns and 12 microns.

The oxide coating of the embodiments reacts well with the HF acid. It produces solid materials that do not damage batteries and reduces the corrosion of the active materials of positive electrodes by HF acid. As a result, the cycling properties of the batteries are improved, especially at high temperatures.

The coating of oxide on the surface of the active material of positive electrodes forms a transitional layer between the active material of positive electrodes and the electrolyte. This transitional layer reduces the diffusion rate of lithium ions at the surface of active material of positive electrodes. As a result, the diffusion rate of lithium ions in the electrodes and electrolyte are stabilized and the cycling properties of the batteries involved are improved.

The preferred embodiments of the present invention also discloses methods for fabricating materials for positive electrodes of lithium ion batteries. In one method, there are the following steps:
mixing uniformly granules of an active material for positive electrodes and an additive in either water or an organic solvent;
evaporating said organic solvent or water to obtain a composite of said granules of active material and additive; and
heating said composite at between 300° C. to 900° C. for between 1 hour to 20 hours to obtain said material for said positive electrode.

The active materials of the embodiments are granules and are one or more of the following: oxides of lithium cobalt, oxides of lithium nickel cobalt, oxides of lithium nickel cobalt manganese, oxides of lithium manganese, LiCoO₂, LiNi₁₋ₓCoₓO₂, LiNi₁₋ₓCoₓO₂ where o<x<1, LiNi_{1/3}Co_{1/3}Mn/_{1/3}O₂, and LiMn₂O₄.

The average granule diameter of the granules of active material for positive electrodes for some embodiments is between 4 microns and 12 microns. A preferred selection is for the average granule diameters to be between 10 microns and 12 microns.

The additive in some embodiments is the compound of one or more of the following metal element: aluminum, magnesium, zinc, calcium, barium, strontium, lanthanum, cerium, vanadium, titanium, tin, Al, Mg, Zn, Ca, Ba, Sr, La, Ce, V, Ti, and Sn, or the following nonmetal element: silicon, boron, Si, and B. The weight of the all the metal or nonmetal elements listed above in said additive is between 0.01 wt. % to 10 wt. % of the weight of the granules of active material for positive electrodes.

Embodiments of this invention provide the methods for the fabrication of materials for the positive electrodes using a liquid phase method. After heat treatment, the additives produce an oxide coating on the surface of the granules of active materials for the positive electrodes. Coated by this layer, active materials for the positive electrodes have smaller structural changes during the charging and discharging process.

Raw material for making the active materials for the positive electrodes can be either bought from the market or fabricated in house. Lithium cobalt oxide, for example, can be prepared by heat-treating Li₂CO₃, LiOH, or LiNO₃ with Co₃O₄ at 600° C. to 900° C. for 5 to 20 hours. The average granule diameter of the granules of active material is selected to be between 4 microns to 12 microns with an optimal range of between 10 microns to 12 microns. The larger the granules, the more apparent are the effects of the additives. If the granule diameter of the granules of active materials of positive electrodes is too small, it can easily form mixtures with the additives such that the additives do not form a uniform coating on the surface of the granules of active material. In addition, the oxide obtained from heat treatment of the additives can easily penetrate into the granules of active material for the positive electrodes to form a body-phase mixture. This reduces the capacity of the batteries. The average granule diameter, D₅₀, is measured using a laser scattering granular analyzer.

The additives in the embodiments, after being heated, decompose into its corresponding oxide. Research results showed that compounds of Al, i.e., aluminum, are significantly more effective than the other additives and thus is the preferred additive. Any aluminum compound that can dissolve in water or organic solvent and can decompose into Al₂O₃ after heating, such as aluminum nitrate, aluminum isopropanol and aluminum butanol, can be used. The preferred selection is aluminum nitrate since this compound is safer than aluminum isopropanol and aluminum butanol.

In the embodiments, the metal or non-metal elements in the compounds of metal or non-metal elements are 0.01 wt. % to 10 wt. % of granules of the active material for the positive electrodes. That is, the total weight of the metal or nonmetal elements in the compounds of metal or nonmetal elements for the additives is 0.01 wt. % to 10 wt. % of the granules of active materials for positive electrodes. After heat treatment, the additives decompose and form an oxide. The non-oxygen component of the oxide layer, that is, the compound of the metal or non-metal element stated above, is then 0.01 wt. % to 10 wt. % of the granules of the active materials for the positive electrodes. For example, the weight of the Al element should be 0.01 wt. % to 10 wt. % of the granules of active materials for the positive electrodes when the additive is aluminum nitrate. If weight of the metal or non-metal element in the additive is less than 0.01 wt %, it cannot form a complete coating layer on the entire granules of active materials. As a result, no clear additive effect can be achieved. Increasing the weight of the additive element to greater than 10 wt % does not produce more apparent improvement to the cycling properties. Instead, the performance of batteries using such materials in positive electrodes is negatively impacted as their capacities decrease noticeably.

The uniformly mixed composite of additives and granules of active materials of positive electrodes must be heated at 300° C. to 900° C. for 1 hour to 20 hours to produce the corresponding oxide coating. If the temperature is too high or the mixture is heated too long, the oxide produced can penetrate into the inner part of the granules of active material for positive electrodes, forming a body-phase mixture. This will lower the capacity of batteries using the materials fabricated in positive electrodes. If the temperature is too low, or mixture is heated for too short a period, the additives do not completely decompose to produce oxides. This will affect the conductivity of the resulting materials for positive electrodes. The properties of batteries using such materials in their positive electrodes will be negatively affected, as the internal resistance of these batteries will be increased.

The following embodiments further describe this invention in more detail.

### Embodiment 1

A. Fabrication of Materials for the Positive Electrodes:

Li₂CO₃ and CO₃O₄ are uniformly mixed where Li/Co is in the molar ratio of between 1:1 and 1.1. Said mixture is then heat treated at 900° C. for 10 hours to obtain lithium cobalt oxide with an average granule diameter of 10 microns to 12 microns.

Aluminum nitrate is used as the additive where the aluminum element in aluminum nitrate is 0.1 wt % of the lithium cobalt oxide. This additive is dissolved in anhydrous ethanol. Lithium cobalt oxide is then added to the lithium cobalt oxide in anhydrous ethanol and mixed uniformly. The solvent is evaporated and the resulting composite is heat treated at 800° C. for 4 hours to obtain the material for the positive electrodes of this embodiment.

B. Fabrication of Positive Electrode Slice:

85 wt. % of the materials for positive electrodes that has been fabricated by the method described above, 10 wt % of graphite, the conducting agent, and 5 wt. % of PVDF (polyvinylidene fluoride), the binder, are added into a NMP (methyl-2-pyrrolidinone) solvent. The mixture is stirred well to form an emulsion in order to obtain a slurry mixture of material for the positive electrodes. This slurry mixture is uniformly coated onto both sides a belt-shaped aluminum foil. It is then dried with heat and pressed to form a belt-shaped positive electrode.

C. Fabrication of Negative Electrode Slice:

90 wt. % of graphite and 10 wt. % of PVDF are added into a NMP solvent. The mixture is stirred well to obtain a slurry mixture of negative electrode material. This slurry mixture is then uniformly coated onto both sides of a belt-shaped copper foil. It is then dried with heat and pressed to form a belt-shaped negative electrode.

Preparation for Electrolyte

The electrolyte is a solution obtained by dissolving lithium hexafluorophosphate (LiPF₆) in a solvent that is formed by mixing equal volumes of EC (ethylene carbonate) and DMC (dimethyl carbonate). The concentration of LiPF₆ is 1 mol/L.

D. Assembly of Battery:

In one method for the assembly of the battery, the positive electrode and negative electrode that have been fabricated as described above are wrapped many times with a multi-porous polyalkene membrane to obtain a wrapped electrode. The wrapped electrodes are placed in the outer shell of the battery. Insulating plates are also placed on the top and bottom of the electrodes. Electrolyte is then injected into the battery's outer shell containing electrodes. The battery is sealed with an insulating gasket. The safety valve, PTC component and battery cover are secured to obtain a cylindrical battery whose outer diameter is 18 mm and whose height is 65 mm.

### Embodiment 2

In this embodiment, the weight of the aluminum element in aluminum nitrate is increased to 5 wt. % of the weight of lithium cobalt oxide. Except for this, all other fabrication methods and conditions remain the same as Embodiment 1.

### Embodiment 3

In this embodiment, the weight of the aluminum element in aluminum nitrate is increased to 10 wt. % of the weight of lithium cobalt oxide. Except for this, all other fabrication methods and conditions remain the same as Embodiment 1.

### Embodiment 4

In this embodiment, the additive is aluminum isopropanol instead of aluminum nitrate. Except for this, all other fabrication methods and conditions remain the same as Embodiment. 1.

### Embodiment 5

In this embodiment, the additive is magnesium nitrate instead of aluminum nitrate. Except for this, all other fabrication methods and conditions remain the same as Embodiment. 1.

### Embodiment 6

In this embodiment, the condition for heat treatment to fabricate the material for the positive electrodes is changed to heating at 500° C. for 10 hours. Except for this, all other fabrication methods and conditions remain the same as Embodiment. 1.

### Embodiment 7

In this embodiment, the additive is silica acid ethyl ester instead of aluminum nitrate. Except for this, all other fabrication methods and conditions remain the same as Embodiment. 1.

### COMPARISON EXAMPLE 1

In this embodiment, the weight of the aluminum element in aluminum nitrate is increased to 15 wt. % of the weight of lithium cobalt oxide. Except for this, all other fabrication methods and conditions remain the same as Embodiment 1.

### COMPARISON EXAMPLE 2

In this embodiment, the lithium cobalt oxide is prepared in the same manner as Embodiment 1. Li₂CO₃ and Co₃O₄ are uniformly mixed where Li/Co is in the molar ratio of between 1:1 and 1.1. Said mixture is then heat treated at 900° C. for 10 hours to obtain lithium cobalt oxide with an average granule diameter of 10 microns to 12 microns. However, the material for the positive electrode is prepared without the addition of the additive aluminum nitrate. Except for this, all other fabrication methods and conditions remain the same as Embodiment 1, including the fabrication of the positive and negative electrodes and electrolyte and the assembly of the battery.

### COMPARISON EXAMPLE 3

In this embodiment, the lithium cobalt oxide is prepared in the same manner as Embodiment 1. Li₂CO₃ and Co₃O₄ are uniformly mixed where Li/Co is in the molar ratio of between 1:1 and 1.1. Said mixture is then heat treated at 900° C. for 10 hours to obtain lithium cobalt oxide with an average granule diameter of 10 microns to 12 microns. However, the material for the positive electrode is prepared without heat treatment, i.e., using the non-liquid phase method, after the addition of aluminum oxide powder to lithium cobalt oxide. Except for this, all other fabrication methods and conditions remain the same as Embodiment 1, including the fabrication of the positive and negative electrodes and electrolyte and the assembly of the battery.

Conditions for the Testing of the Properties of Batteries

The testing of the properties of the charge-discharge cycles of the batteries are conducted under the following conditions:

Batteries were charged and discharged between 3.0V and 4.2V at a current rate of 1 C.

The specific discharge capacity for the positive electrode is obtained by dividing the discharge capacity by the weight of materials for positive electrode.

The discharge capacity measured during the second cycle is the initial discharge capacity.

The initial specific discharge capacity of the materials for the positive electrode is the initial discharge capacity divided by the weight of materials for positive electrode.

The capacity residual rate for the nth cycle is the discharge capacity of the nth cycle divided by the initial discharge capacity.

In these calculations, the weight of materials for positive electrode is the total weight of active materials for positive electrodes and the oxide layer.

Table 1 shows the test results for the charging and discharging at a current rate of 1C and at 25° C. while Table 2 shows the test results for the charging and discharging at a current rate of 1C and at 60° C.

TABLE 1

| | Specific Capacity of Materials | | | | |
|---|---|---|---|---|---|
| | for Positive Electrodes (mAh/g) | | | | |
| | Initial | | | Capacity Residual Rate | |
| | Discharge | 100th Cycle | 400th Cycle | 100th Cycle | 400th Cycle |
| Embodiment 1 | 140 | 136 | 132 | 97% | 94% |
| Embodiment 2 | 137 | 134 | 130 | 98% | 95% |
| Embodiment 3 | 131 | 128 | 126 | 98% | 96% |
| Embodiment 4 | 140 | 134 | 130 | 96% | 93% |
| Embodiment 5 | 139 | 133 | 122 | 96% | 88% |
| Embodiment 6 | 139 | 135 | 131 | 97% | 94% |
| Embodiment 7 | 139 | 132 | 120 | 95% | 86% |
| Comparison Example 1 | 120 | 118 | 115 | 98% | 96% |
| Comparison Example 2 | 140 | 126 | 112 | 90% | 80% |
| Comparison Example 3 | 139 | 131 | 114 | 94% | 82% |

TABLE 2

| | Specific Capacity of Materials | | | | |
|---|---|---|---|---|---|
| | for Positive Electrodes | | | Capacity | |
| | (mAh/g) | | | Residual Rate | |
| | Initial | 100th | | | 400th |
| | Discharge | Cycle | 400th Cycle | 100th Cycle | Cycle |
| Embodiment 1 | 140 | 130 | 122 | 93% | 87% |
| Embodiment 2 | 137 | 127 | 121 | 93% | 88% |
| Embodiment 3 | 131 | 123 | 117 | 94% | 89% |
| Embodiment 4 | 140 | 130 | 120 | 93% | 86% |
| Embodiment 5 | 139 | 125 | 114 | 90% | 82% |
| Embodiment 6 | 139 | 129 | 120 | 93% | 86% |
| Embodiment 7 | 139 | 125 | 114 | 90% | 82% |
| Comparison | 120 | 113 | 108 | 94% | 90% |
| Example 1 | | | | | |
| Comparison | 140 | 119 | 99 | 85% | 71% |
| Example 2 | | | | | |
| Comparison | 139 | 121 | 104 | 87% | 75% |
| Example 3 | | | | | |

Table 3 shows the test results of the charge-discharge characteristics at 1C/0.5C, 2C/0.5C, 3C/0.5C and at 25° C.

TABLE 3

| | Charge/Discharge Characteristics | | |
|---|---|---|---|
| | 1 C./0.5 C. | 2 C./0.5 C. | 3 C./0.5 C. |
| Embodiment 1 | 98% | 95% | 90% |
| Embodiment 2 | 99% | 96% | 92% |
| Embodiment 3 | 99% | 96% | 92% |
| Embodiment 4 | 98% | 95% | 90% |
| Embodiment 5 | 97% | 94% | 88% |
| Embodiment 6 | 98% | 95% | 90% |
| Embodiment 7 | 98% | 94% | 89% |
| Comparison | 99% | 96% | 93% |
| example 1 | | | |
| Comparison | 97% | 93% | 84% |
| example 2 | | | |
| Comparison | 96% | 93% | 85% |
| example 3 | | | |

The charged battery is also disassembled and the material for positive electrodes dried with heat. Differential scanning calorimeter (DSC) measurements of the materials are conducted in air. (The instrument used is NETSCH STA 449C). The temperature is then increased at a rate of 3° C./min for temperatures between 20° C. and 500° C. to obtain the decomposition temperature of the charged material for positive electrodes. The test results are showed in Table 4.

TABLE 4

| | Decomposition temperature (° C.) |
|---|---|
| Embodiment 1 | 248 |
| Embodiment 2 | 256 |
| Embodiment 3 | 258 |
| Embodiment 5 | 245 |
| Comparison Example 1 | 259 |
| Comparison Example 2 | 238 |

The data from Tables 1 to 4 shows that cycling properties, high temperature and safety characteristics, high current charge-discharge properties and overcharge resistance properties of lithium cobalt oxide are much improved after being treated with additives. The higher the content of the additive, the more apparent is the improvement of the properties. However, the reduction of the capacity is also more apparent.

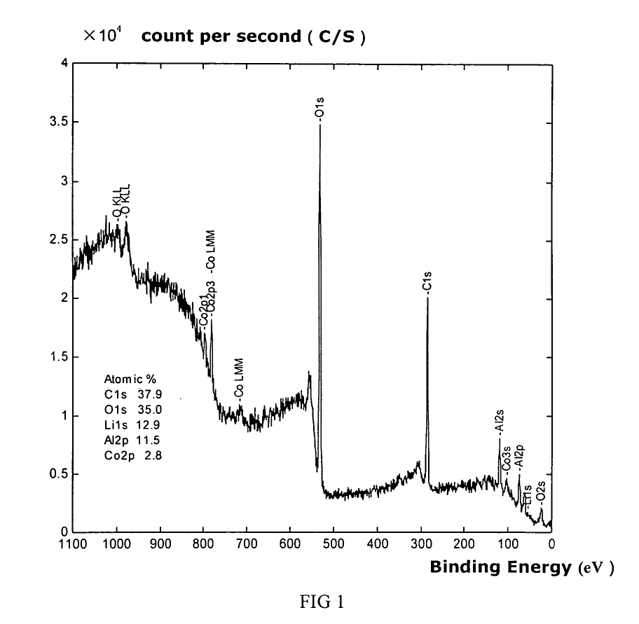

FIG. 1 is the XPS graph of the material for positive electrodes from Embodiment 1, obtained by X-ray photoelectron spectroscopy. (The instrument used is the 5800 X-ray photoelectron spectroscope from PHI Corporation, USA). The measurement conditions are the following: Al—K^{α} (1486.6 eV) monochrome ray is used. The environment pressure is 2*10⁻¹⁰ TORR. FIG. 1 shows that the Al concentration is high at the surface of LiCoO₂. This indicates that the coating at the surface of LiCoO₂ is successful.

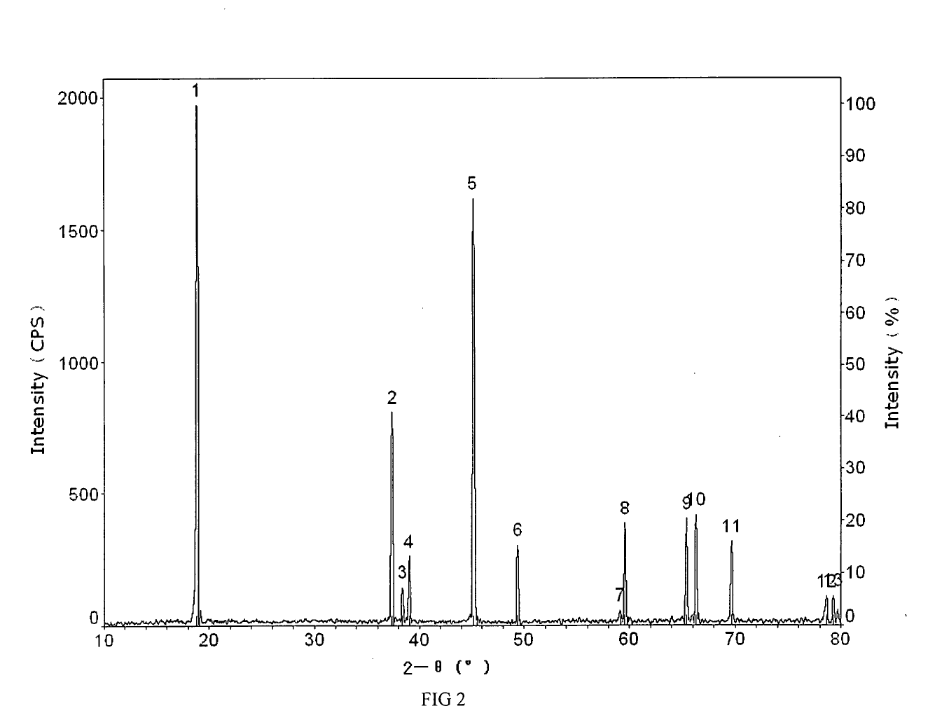

FIG. 2 is the XRD graph of the material for positive electrodes from Embodiment 1, obtained with a X-Ray diffractometer. (The instrument used is D/MAX-2200/PC X-Ray diffractometer from Rigaku Corporation.) Measurement conditions are as follows: the rate of Cu Kα scanning between 2θ=10° and 80° is 4°/min; the tube pressure is 40 KV; and the tube current is 20 mA. FIG. 2 shows that the LiCoO₂ of this embodiment has a typical diamond layer structure of α-NaFeO₂, which belongs to R3m spatial cluster.

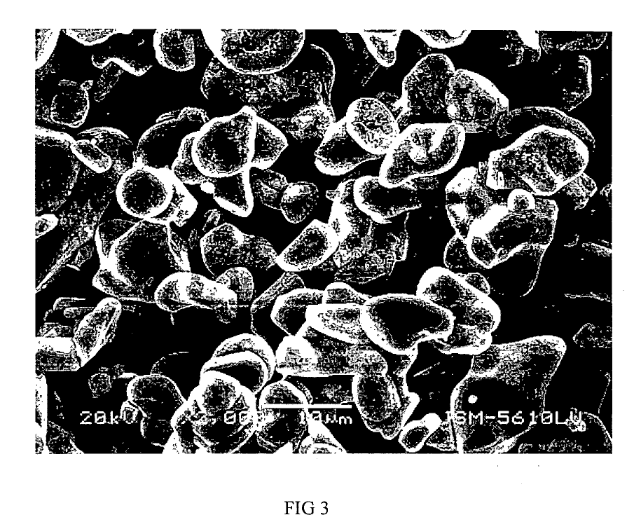

FIG. 3 is the scanning electron micrograph of the material for positive electrodes from Embodiment 1. (The instrument used is JSM-5610LV from JEOL company, Japan). The accelerate voltage of measurement is 20 KV. It can be seen from FIG. 3 that the surface of LiCoO₂ is very smooth, the size of particle is uniform, and the average granule diameter is around 11 microns.

The test results using the above embodiments show the materials for positive electrodes of this invention, when used in lithium ion batteries, produces batteries with better cycling properties, excellent high temperature, high rate discharge and overcharge resistance properties. The method of fabrication is simple and easy to implement for manufacturing.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

1. A material for positive electrodes, comprising:
granules of active material for said positive electrode; and
an oxide coating for each of said granules of said active material comprising of an oxygen component and a non-oxygen component; and wherein
said active material is at least one lithium compound selected from the group consisting of: an oxide of lithium cobalt, an oxide of lithium nickel cobalt, an oxide of lithium nickel cobalt manganese, an oxide of lithium manganese, LiCoO₂, LiNi₁₋ₓCoₓO₂, LiNi_{1/3}Co_{1/3}Mn_{1/3}O₂, and LiMn₂O₄.

2. The material for positive electrodes of claim 1 wherein said non-oxygen component of said oxide coating of one or more of said granules is between 0.1 wt. % to 10 wt. % of said respective granule of active material.

3. The material for positive electrode of claim 1 wherein each of said granules having an average granule diameter between 4 microns and 12 microns.

4. The material for positive electrode of claim 1 wherein said non-oxygen component of said oxide coating is at least one metal selected from the group consisting of: aluminum, magnesium, zinc, calcium, barium, strontium, lanthanum, cerium, vanadium, titanium, tin, Al, Mg, Zn, Ca, Ba, Sr, La, Ce, V, Ti, and Sn.

5. The material for positive electrode of claim 1 wherein said non-oxygen component of said oxide coating is at least one non-metal element selected from the group consisting of: silicon, boron, Si, and B.

6. The material for positive electrode of claim 1 wherein said non-oxygen component of said oxide coating is at least one element selected from the group consisting of: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B.

7. The material for positive electrode of claim 4 wherein said non-oxygen component of said oxide coating of one or more of said granules is between 0.1 wt. % to 10 wt. % of said respective granule of active material.

8. The material for positive electrode of claim 5 wherein said non-oxygen component of said oxide coating of one or more of said granules is between 0.1 wt. % to 10 wt. % of said respective granule of active material.

9. The material for positive electrode of claim 6 wherein said non-oxygen component of said oxide coating of one or more of said granules is between 0.1 wt. % to 10 wt. % of said respective granule of active material.

10. The material for positive electrode of claim 6 wherein each of said granules having an average granule diameter between 4 microns and 12.

11. The material for positive electrode of claim 9 wherein each of said granules having an average granule diameter between 4 microns and 12

12. A method for fabricating a material for positive electrodes, comprising the steps of:
mixing granules of an active material and an additive in a solution;
evaporating said solution to obtain a composite of said granules of active material and additive;
heating said composite at between 300° C. to 900° C. for between 1 hour to 20 hours to obtain said material for said positive electrode; and wherein
said active material is at least one lithium compound selected from the group consisting of: an oxide of lithium cobalt, an oxide of lithium nickel cobalt, an oxide of lithium nickel cobalt manganese, an oxide of lithium manganese, LiCoO₂, LiNi₁₋ₓCoₓO₂, LiNi_{1/3}Co_{1/3}Mn_{1/3}O₂, and LiMn₂O₄.

13. The method for fabricating a material for positive electrodes in claim 12 wherein each of said granules having an average granule diameter between 4 microns and 12 microns.

14. The method for fabricating a material for positive electrodes in claim 12 wherein each of said granules having an average granule diameter between 10 microns and 12 microns.

15. The method for fabricating a material for positive electrodes of 12 wherein said additive is a compound of one or more element selected from the group consisting of: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B.

16. The method for fabricating a material for positive electrodes of claim 15 wherein said elements in said additive is between 0.1 wt. % to 10 wt. % of said active material.

17. The method for fabricating a material for positive electrodes in claim 15 wherein each of said granules having an average granule diameter between 4 microns and 12 microns.

18. The method for fabricating a material for positive electrodes in claim 16 wherein each of said granules having an average granule diameter between 4 microns and 12 microns.

19. The method for fabricating a material for positive electrodes of claim 12 wherein said solution is water or an organic solvent.

20. A material for positive electrodes, comprising:
granules of active material for said positive electrode; and
an oxide coating for each of said granules comprising of an oxygen component and a non-oxygen component; and wherein
said active material is at least one lithium compound selected from the group consisting of: an oxide of lithium cobalt, an oxide of lithium nickel cobalt, an oxide of lithium nickel cobalt manganese, an oxide of lithium manganese, LiCoO₂, LiNi₁₋ₓCoₓO₂, LiNi_{1/3}Co_{1/3}Mn_{1/3}O₂, and LiMn₂O₄;
said non-oxygen component of said oxide coating of one or more of said granules is between 0.1 wt. % to 10 wt. % of said respective granule of active material;
each of said granules having an average granule diameter between 4 microns and 12 microns; and
said non-oxygen component of said oxide coating is at least one element selected from the group consisting of: aluminum, magnesium, zinc, calcium, barium, strontium, lanthanum, cerium, vanadium, titanium, tin, silicon, boron, Al, Mg, Zn, Ca, Ba, Sr, La, Ce, V, Ti, Sn, Si, and B.
